(19) United States
(12) Patent Application Publication
(10) Pub. No.: US 2023/0043906 A1
(43) Pub. Date: Feb. 9, 2023

(54) ANTI-SLIP FLOOR TILE AND METHOD OF MAKING AN ANTI-SLIP FLOOR TILE

(71) Applicant: Traction Technologies Holdings, LLC, Detroit, MI (US)

(72) Inventors: William R. DAVIDSON, Brookings, SD (US); Jeffrey R. BAKER, Clinton Township, MI (US)

(21) Appl. No.: 17/882,417

(22) Filed: Aug. 5, 2022

Related U.S. Application Data
(60) Provisional application No. 63/230,158, filed on Aug. 6, 2021.

(51) Int. Cl. E04F 15/02; C09K 3/14

(52) U.S. Cl. CPC E04F 15/02172; C09K 3/149

(57) ABSTRACT

A method is disclosed for making a floor tile having ceramic tiles formed in situ in openings or recesses in the plate. A metal frame is embossed to form recesses in one embodiment. In another embodiment, openings are punched in the plate and a backing plate is attached to a bottom surface of the plate. A ceramic composition is poured into the plurality of openings up to a level that is below the upper surface of the metal frame and is cured to form a ceramic tile in situ in each of the plurality of openings. Surface features may be provided in the recesses or openings such as projections with a head portion that are embedded in the ceramic composition after curing.

### REFERENCE TO RELATED APPLICATIONS

This application claims the benefit of U.S. provisional application Ser. No. 63/230,158 filed Aug. 6, 2021, the disclosure of which is hereby incorporated in its entirety by reference herein.

### TECHNICAL FIELD

This disclosure is directed to a method of making an anti-slip floor tile and the floor tile made by the method.

### BACKGROUND

Floor tiles are used in a wide variety of applications and are used for their aesthetic appeal, durability, and ease of installation. Floor tile products may be made of ceramic, glass, granite, marble, wood and other hard surface materials. One problem with such floors is that they may become slippery when wet when used in areas such as building lobbies or commercial kitchens. These types of flooring applications are frequently exposed to surface hazards such as water and spilled food, beverages, and cooking products.

This disclosure is directed to solving the above problems and other problems as summarized below.

### SUMMARY

According to one aspect of this disclosure, a method of making a floor tile is disclosed wherein a ceramic composition is provided in openings defined by a metal frame. The method begins by providing a metal frame that defines a plurality of openings. An anti-slip coating is applied to an upper surface of the metal frame. A base plate is attached to a bottom surface of the metal frame. A ceramic composition is poured into the plurality of openings up to a level that is below the upper surface of the metal frame. The ceramic composition is cured in the plurality of openings to form a ceramic tile in situ in each of the plurality of openings.

The base plate may include surface features on an upper surface of the base plate that extend into the openings and are covered by the ceramic composition. The surface features are projections having a head portion that is embedded in the ceramic tile after the curing step.

Alternatively, the base plate may be coated with the anti-slip coating to provide a clean, textured surface to which the ceramic composition may bond when the ceramic composition is cured.

The step of applying the anti-slip coating may be performed by spraying a molten metal coating on the top surface of the metal framework.

The metal tile support panel is preferably made of aluminum, or an aluminum alloy, but may also be formed of another metal such as stainless steel, steel, copper, brass, or the like. The anti-slip coating is preferably stainless steel or a stainless steel alloy but may also be formed of another metal.

The anti-slip coating is a metal coating that is metalized (applied by plasma stream deposition) on the plurality of intersecting strips. The anti-slip coating may be applied by other metal-on-metal application technique provided that the coating provides a textured surface.

According to a second aspect of this invention, a method is disclosed for making a floor tile having an anti-slip coating provided on areas of the floor tile that are raised relative to a ceramic tile formed in situ in recesses defined by the metal panel. The method includes the step of providing a metal panel defining a plurality of recesses, applying a metal anti-slip coating to an upper surface of the metal panel, pouring a ceramic composition into the plurality of recesses up to a level that is below the upper surface of the metal frame, and curing the ceramic composition in the plurality of recesses to form a ceramic tile in situ in each of the plurality of openings.

Alternatively, the metal panel may include surface features on an upper surface of the base plate that extend into the recesses and are covered by the ceramic composition. The surface features may be projections having a head portion that is embedded in the ceramic tile after the curing step.

The anti-slip coating may be applied to the recesses of the metal panel to provide a clean textured surface to which the ceramic composition bonds when cured.

According to another aspect of this disclosure, an article of manufacture is disclosed the includes a metal member that defines a plurality of lower areas having a depth D below a plurality of upper areas having a height from which the depth D is measured, wherein at least the upper areas are provided with a metal anti-slip coating, and a ceramic tile bonded to the lower areas, wherein the ceramic tile has a height H that is less than the depth D of the lower areas.

Optional or alternative aspects of the article of manufacture are described below.

The lower areas may be provided with a metal anti-slip coating. The metal panel mat include surface features in the lower areas that extend into the lower areas and are imbedded in the ceramic tile. The surface features may be projections having a head portion that is embedded in the ceramic tile.

The metal member is a metal panel that defines a plurality of recesses.

Alternatively, the metal member is a metal frame defining a plurality of openings, and a base plate assembled to a bottom surface of the metal frame.

The metal anti-slip coating may be a stainless steel coating that is applied to the metal panel, wherein the metal panel is a rough surface. The metal panel may be aluminum.

The above aspects of this disclosure and other aspects will be described below with reference to the attached drawings.

### BRIEF DESCRIPTION OF THE DRAWINGS

FIG. 1 is a top perspective view of a floor tile made according to one embodiment of this disclosure.

FIG. 2 is an exploded perspective view of the components of the floor tile including a base plate, a metal frame and an uncured ceramic composition.

FIG. 3 is a top plan view of the floor tile with ceramic tiles formed in-situ in openings defined by the metal framework and the base plate.

FIG. 4 is a cross-section view taken along the line 4-4 in FIG. 3.

FIG. 5 is of an alternative embodiment of the floor tile assembly wherein the ceramic forming composition is deposited in a recess defined by the framework and is a cross section corresponding to the cross section of FIG. 4.

FIG. 6 is a flow chart illustrating the steps of a method of making and installing the floor tile shown in FIGS. 1-4.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Various features illustrated and described with reference to any one of the figures may be combined with features illustrated in one or more of the other figures to produce embodiments that are not explicitly illustrated or described. The combinations of features illustrated provide representative embodiments for typical applications. Various combinations and modifications of the features consistent with the teachings of this disclosure could be used in particular applications or implementations.

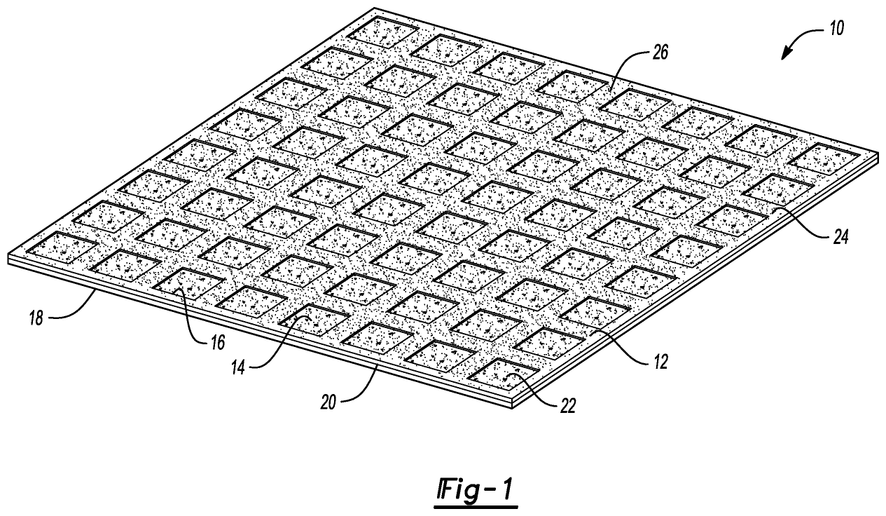

Referring to FIGS. 1-5, a floor tile assembly 10 is illustrated in FIG. 1 that includes a metal framework 12 (hereinafter “framework”) and a plurality of tiles 14. The framework 12 may also be referred to as a metal tile support panel. The tiles 14 are made of ceramic that is formed in-situ in openings 16, or recesses, defined by the framework 12. A base plate 18 may be secured to a bottom surface 20 of the framework 12 to close one side of the openings 16 in the framework 12. Alternatively, the framework 12 may define recesses to eliminate the need for a base plate 18. The tiles 14 have a top surface 22 that is recessed relative to an upper surface 24 of the framework 12. The upper surface 24 of the framework 12 is coated with an anti-slip coating 26 that is formed by spraying molten metal on the upper surface 24 of the framework 12.

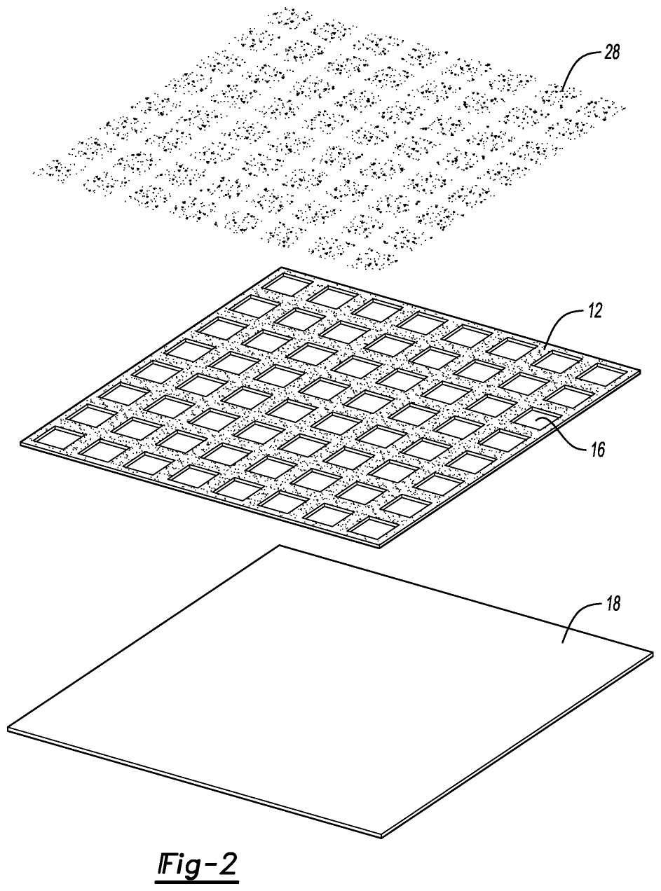

Referring to FIG. 2, the components of the floor tile 10 are shown in a diagrammatic exploded perspective view. The framework 12 is shown above the base plate 18 and is oriented in the view to be attached to the base plate 18. A ceramic forming composition 28 is shown above the framework 12 in the view that is aligned with the openings 16 to the framework 12. The ceramic forming composition 28 is a nonmetallic material that may be supplied in the openings 16 as a powder, liquid, or a paste. The ceramic forming composition 28 is fired, or heated, to form a hard, heat-resistant, and corrosion resistant vitrified tile 14 in each of the openings 16, or recesses.

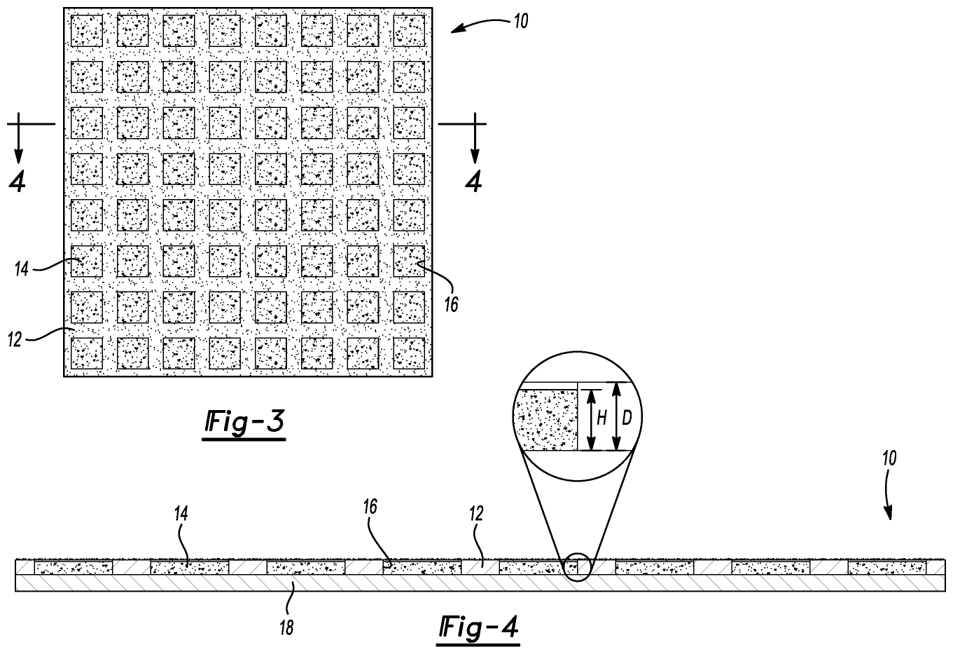

Referring to FIGS. 3 and 4, the floor tile assembly 10 is shown that includes openings 16 and tiles 14 that are square in shape. The tiles 14 and openings 16 may be rectilinear, circular, ovate, or irregular in shape. The framework 12 is preferably made of aluminum or an aluminum alloy to minimize the weight of the floor tile assembly 10. Alternatively, the framework 12 may be made of steel, stainless steel, or another metal or metal alloy. As shown in FIG. 4, the framework 12 may be punched or otherwise pierced to form the openings 16. The base plate 18 is shown to be attached to the bottom surface 20 of the framework 12. The openings 16 have a depth D and the tiles 14 have a height H that is less than D.

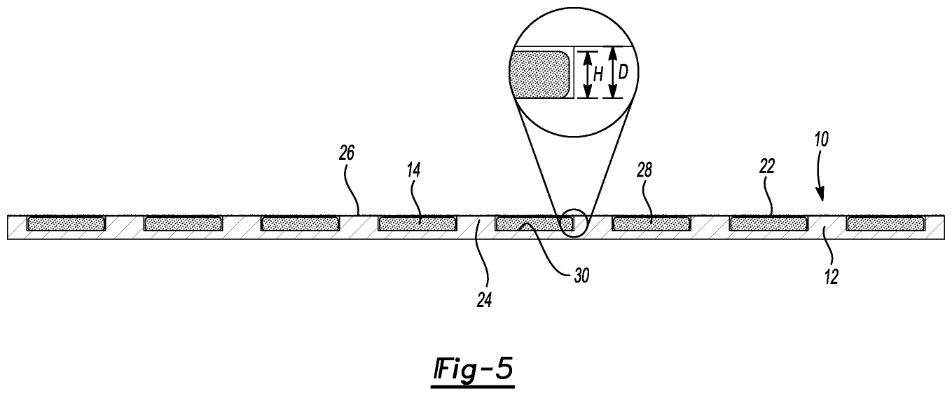

Alternatively, as shown in FIG. 5, the framework 12 may be stamped to define a plurality of recesses 20 in the upper surface 24 that are adapted to receive the ceramic forming composition 28. The anti-slip coating 26 applied to the upper surface 24 of the framework 12 is above the top surface 22 of the tiles 14 to assure that a person walking on the floor tile assembly 10 will contact the anti-slip coating 26 on the framework 12. The recesses 30 have a depth D and the tiles 14 have a height H that is less than D.

In either case, the anti-slip coating 26 on the framework 12 is preferably made of a stainless steel alloy to provide a surface that does not corrode and provide a hard, durable surface covering the framework 12. The stainless steel alloy is preferably applied to the upper surface 24 by spraying molten stainless steel from welding wires (not shown) in an arc-welding process onto the upper surface 18. The process is described in applicant's prior U.S. Pat. No. 5,711,118 the disclosure of which is incorporated by reference.

The tiles 14 are attached to the framework 12 when the ceramic forming composition is fired to form a vitrified tile 14 in the openings 16 or recesses 30.

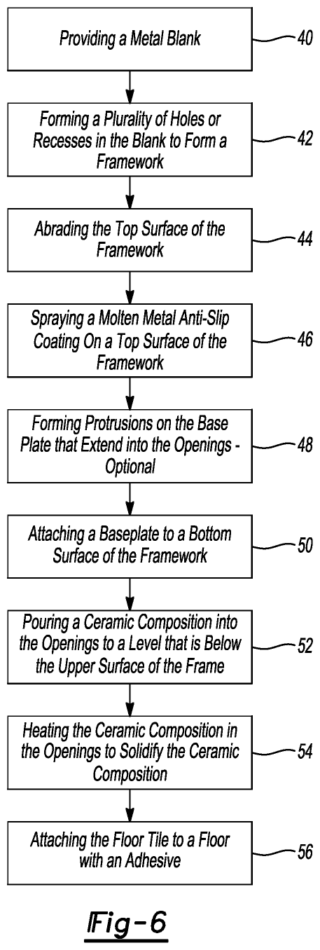

Referring to FIG. 6, a method of making and installing the floor tile assembly 10 of FIGS. 1-5 is illustrated by a flow chart. According to the method, a metal blank is provided at 40 that is then stamped or punched at 42 to form the plurality of openings 16 or recesses 30 in the frameworks 12. The upper surface 24 of the framework 12 is abraded at 44 to clean and roughen the upper surface 24. At 46, a molten metal anti-slip coating 26 is sprayed on the upper surface of the framework 12. At 48, an optional step is performed wherein protrusions 32 are welded or otherwise formed on the baseplate 18 that extend into the openings 16. The protrusions 32 are provided to enhance the connection of the ceramic forming composition 28 to the base plate 18. The ceramic forming composition 28 when vitrified conforms to the protrusions 32 and mechanically lock the tiles 14 to the base plate 18.

As a further alternative, the anti-slip coating 26 may be applied to the portions of the base plate 18 exposed through the openings 16. In this case, the base plate 18 may be attached to the bottom surface 20 of the framework 12 before the steps of abrading the surface and applying the anti-slip coating 26. The anti-slip coating 26 applied to the base plate 18 provides a clean surface for bonding to the ceramic forming composition 28.

The base plate at 50 is attached to the bottom surface 20 of the framework 12. The ceramic forming composition 28 is poured or otherwise deposited in the openings 16 at 52 up to a level that is below the upper surface 24 of the framework 12. The ceramic forming composition 28 is heated in the openings to solidify, or vitrify, the composition and thereby form the tiles 14 in-situ, at 54. At this point manufacture of the floor tile assembly is complete and the floor tile assembly is ready to be installed on a floor. The floor tile assembly is then attached at 56 to the floor with a tile adhesive.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments. In addition, the features of various implementing embodiments may be combined to form further embodiments of the invention.

What is claimed is:

1. A method of making a floor tile comprising:
providing a metal frame defining a plurality of openings;
applying a metal anti-slip coating to an upper surface of the metal frame;
attaching a base plate to a bottom surface of the metal frame;
pouring a ceramic composition into the plurality of openings up to a level that is below the upper surface of the metal frame; and
curing the ceramic composition in the plurality of openings to form a ceramic tile in situ in each of the plurality of openings.

2. The method of claim 1 wherein the base plate includes surface features on an upper surface of the base plate that extend into the openings and are covered by the ceramic composition.

3. The method of claim 2 wherein the surface features are projections having a head portion that is embedded in the ceramic tile after the curing step.

4. The method of claim 1 wherein the anti-slip coating is applied to the portions of the base plate exposed by the openings to provide a clean textured surface to which the ceramic composition bonds when cured.

5. A method of making a floor tile comprising:
providing a metal panel defining a plurality of recesses;
applying a metal anti-slip coating to an upper surface of the metal panel;
pouring a ceramic composition into the plurality of recesses up to a level that is below the upper surface of the metal frame; and
curing the ceramic composition in the plurality of recesses to form a ceramic tile in situ in each of the plurality of openings.

6. The method of claim 5 wherein the metal panel includes surface features on an upper surface of the base plate that extend into the recesses and are covered by the ceramic composition.

7. The method of claim 6 wherein the surface features are projections having a head portion that is embedded in the ceramic tile after the curing step.

8. The method of claim 5 wherein the anti-slip coating is applied to the recesses of the metal panel to provide a clean textured surface to which the ceramic composition bonds when cured.

9. An article of manufacture comprising:
a metal member that defines a plurality of lower areas having a depth D below a plurality of upper areas having a height from which the depth D is measured, wherein at least the upper areas are provided with a metal anti-slip coating; and
a ceramic tile bonded to the lower areas, wherein the ceramic tile has a height H that is less than the depth D of the lower areas.

10. The article of manufacture of claim 9 wherein the lower areas are provided with a metal anti-slip coating.

11. The article of manufacture of claim 9 wherein the metal panel includes surface features in the lower areas that extend into the lower areas and are imbedded in the ceramic tile.

12. The article of manufacture of claim 11 wherein the surface features are projections having a head portion that is embedded in the ceramic tile.

13. The article of manufacture of claim 9 wherein the metal member is a metal panel that defines a plurality of recesses.

14. The article of manufacture of claim 13 wherein the metal panel includes surface features in the lower areas that extend above the lower areas and below the upper areas and are imbedded in the ceramic tile.

15. The article of manufacture of claim 14 wherein the surface features are projections having a head portion that is embedded in the ceramic tile.

16. The article of manufacture of claim 9 wherein the metal member is a metal frame defining a plurality of openings, and a base plate assembled to a bottom surface of the metal frame.

17. The article of manufacture of claim 16 wherein the metal panel includes surface features on the base plate that extend into the lower areas and are imbedded in the ceramic tile.

18. The article of manufacture of claim 17 wherein the surface features are projections having a head portion that is embedded in the ceramic tile.

19. The article of manufacture of claim 9 wherein the metal anti-slip coating is a stainless steel coating that is applied to the metal panel, wherein the metal panel is a rough surface.

20. The article of manufacture of claim 9 wherein the metal panel is aluminum.
